(19) United States
(12) Patent Application Publication
(10) Pub. No.: US 2005/0091011 A1
(43) Pub. Date: Apr. 28, 2005

(54) Method for simulating a technical system and simulator

(76) Inventors: Stefan Bennoit, Mackenrodt, (DE); Claus Hillermeier, Ubersee (DE)

Correspondence Address: HARNESS, DICKEY & PIERCE, P.L.C., P.O.BOX 8910, RESTON, VA, 20195, US

(21) Appl. No.: 10/498,311

(22) PCT Filed: Feb. 24, 2003
(86) PCT No.: PCT/EP03/01865

(30) Foreign Application Priority Data
Mar. 8, 2002 (EP) 02005437.5

(51) Int. Cl. G06F 17/10

(52) U.S. Cl. 703/2

(57) ABSTRACT

A specifically designed buffer store (35) is used in a method according to the invention for simulation of a technical system, from which auxiliary result values (H₁, H₂) of an auxiliary function (25) are read specifically when current values of calling parameters (s₁, s₂, s′₁, s′₂) of the auxiliary function (25) match correspondingly stored values of the calling parameters.

A simulator (60) according to the invention has a correspondingly specifically designed buffer store (35).

The method according to the invention and the simulator according to the invention are in this case based on the discovery that, in many cases, a technical system can be described by a state description which comprises an auxiliary function two or more times and, in particular, with the auxiliary function depending only on some of the state variables of the technical system. This makes it possible to replace a large number of calculations of auxiliary result values of the auxiliary function during the numerical simulation of a technical system by specific reading of auxiliary result values from the buffer store (35).

This application is the national phase under 35 U.S.C. § 371 of PCT International Application No. PCT/EP03/01865 which has an International filing date of Feb. 24, 2003, which designated the United States of America and which claims priority on German Patent Application number EP 02005437.5 filed Mar. 8, 2002, the entire contents of which are hereby incorporated herein by reference.

### FIELD OF THE INVENTION

The invention generally relates to a method and a simulator for simulation of a technical system, in particular of a power station.

### BACKGROUND OF THE INVENTION

In many applications, it is desirable to have a mathematical representation of a technical system in order, for example, to make it possible to predict the operating states of the technical system which can be expected in real conditions. For example, it is thus possible to design and to test a regulator for the technical system without having to intervene in a real technical system in the process, even during the design phase, which could lead to an adverse effect and/or to a hazard during real operation.

Furthermore, a simulator can be used to simulate operating states of the technical system, for example dangerous operating states, which can be produced in the real technical system only with great complexity or even by accepting a risk. Simulators of technical systems can be used advantageously in order to train the operators, who are intended to operate the technical system, in all the operating modes which can be expected, in advance. As such, the operator need not wait to learn how to operate the technical system until faced with real operation.

In order to produce a simulator on a computer, it is necessary to describe the technical system mathematically. Most technical systems can be described by a generally non-linear, higher-order differential equation.

In order to make it possible to simulate the time response on the technical system on a computer, this higher-order differential equation must be solved. Many known simulators and simulation programs use the so-called state space description, which is equivalent to this, in order to solve this multidimensional differential equation.

In this case, the multidimensional differential equation which is, for example, an n-th order differential equation is changed to n first-order differential equations. The equivalence between the n-dimensional differential equations and the n first-order differential equations is known sufficiently as a state space description, in particular in control engineering literature.

A state space description such as this includes, for example, the following state equation:
x′=f(x,t),
where x denotes the so-called state vector, t the time and x′ the time derivative of the state vector x. The function f in this case describes the system dynamics and may also, in general, be non-linear. If the technical system is a so-called time-invariant system, that is to say the system characteristics do not change with time, then the differential equations which describe the system have constant coefficients.

If the intrinsic values of the technical system have magnitudes which differ to a very great extent from one another, then the expression “stiff” is used for the differential equations which describe the system.

Intrinsic system values such as these which have widely differing magnitudes and differ, for example, by two or more orders of magnitude, mathematically describe so-called natural oscillations of the system, whose frequencies differ widely from one another. Thus, in this case, dynamic processes take place on different time axes within the system, for example processes at a low natural frequency on a macro time axis, with processes having a high natural frequency being superimposed on a micro time axis.

The solution to such “stiff” differential equations (that is to say systems with natural oscillations at widely differing frequencies) in particular requires the use of particularly stable numerical solution algorithms.

A range of numerical solution algorithms are known, for example the semi-implicit Euler method or the Rosenbrock method. These known solution algorithms particularly represent stable numerical integration methods, especially for solving the stated “stiff”, differential equation systems.

Virtually all known numerical solution algorithms calculate the so-called Jacobi matrix of the function f when solving the differential equations, with the Jacobi matrix including the partial derivatives of each vector component of f, in each case based on all the components of the state vector x.

The calculation of the Jacobi matrix in each simulation step leads to long computation times, particularly in the case of multidimensional technical systems, since the partial derivatives must be approximated by use of difference quotients in a number of steps.

By way of example, technical systems are modeled by the use of dynamic diagrams in the known Matlab/Simulink software program package. Diagrams such as these include an integrator, adder, multiplier and function blocks (=imaging rules based, for example, on mathematical operations for calculation of output signals from input signals which are applied to the function block).

Numerical differentiation in order to determine the Jacobi matrix requires that one component of the state vector be varied by an amount A in each case successively in order to calculate a difference quotient, which approximates to the differentiation, in one simulation step, with the other components of the state vector each being fixed during this process, and the dynamic diagram being passed through once again. For example, in the case of a system whose order is 100 and whose dynamic diagram in consequence has 100 integrators, this means that this dynamic diagram must be passed through 100 times once again during one simulation step, with one other component of the state vector being varied by an amount Δ in each new run, so that the Jacobi matrix which is required to solve the differential equation system is approximated by the use of the difference quotients determined in this way.

This involves an enormous computation time requirement in each simulation step.

### SUMMARY OF THE INVENTION

An embodiment of the invention therefore may include an object of specifying a method and a simulator for a numerical simulation of a technical system which operate economically and can be used flexibly, particularly with regard to the computation time required for simulation.

With regard to the method, an object may be achieved according to an embodiment of the invention by a method for numerical simulation of a technical system in a number of simulation steps, with the technical system being described by a state description which includes state variables for the technical system, with its Jacobi matrix being used to solve the state description, and with the state description having at least one auxiliary function which is evaluated a number of times repeatedly in each simulation step, and with each simulation step including the following simulation steps:
a) the auxiliary function is evaluated two or more times corresponding to a dynamic diagram which represents the technical system, and the values of the respective calling parameters of the auxiliary function and the respectively associated auxiliary result value for each evaluation are stored in a buffer store,
b) the current value of each state variable is varied successively by a magnitude value while keeping the values of the other state variables constant, and the auxiliary function is evaluated two or more times once again on the basis of the dynamic diagram, with each evaluation comprising a calculation of the respective auxiliary result value if the values of the calling parameters of the current evaluation do not match the values of the calling parameters stored in the buffer store, and comprises reading of the auxiliary result value which is associated with the values of the calling parameters of the current evaluation from the buffer store if the values of the calling parameters for the current evaluation match the values of the calling parameters which are stored in the buffer store, and
c) the Jacobi matrix is determined by means of the auxiliary result values obtained in step b).

An embodiment of the invention may include an idea that, in a large number of technical systems, for example in the case of power stations, the state description of these systems includes at least one auxiliary function which is called repeatedly in order to evaluate the state description in the dynamic diagram. This specific configuration of the state description is typical of technical systems. The method according to an embodiment of the invention makes use of this discovery in that the multiple evaluation of the at least one auxiliary function during the evaluation of the state description is replaced (instead of recalculating it repeatedly) by specific reading of already calculated results from a buffer store.

Particularly when calculating partial derivatives in the state description on the basis of the state variables in order to determine the Jacobi matrix, the multiple runs through the dynamic diagram which are required mean that the auxiliary function must be evaluated many times. Since the calculation of the partial derivatives is carried out numerically by way of difference quotients, the value of one state variable is in each case varied slightly in order to calculate each element of the Jacobi matrix, while the values of the other state variables are kept constant and the dynamic diagram is passed through once again, with the auxiliary function being evaluated a number of times during each run on the basis of the frequency of its occurrence in the state description of the technical system.

As can easily be seen, a large number of repeated evaluations of the auxiliary function are generally carried out in order to determine the Jacobi matrix in each simulation step, in which case their calling parameters often do not change since—as already mentioned—only one state variable is in each case varied in order to calculate the stated difference quotients. For example, the calling parameters do not change during the repeated evaluation of the auxiliary function, if the auxiliary function is dependent only on a first and on a second state variable, but only a third state variable is being varied in that particular calculation step.

If now, as provided in the method according to an embodiment of the invention—the calling parameters and the associated auxiliary result value of the auxiliary function are stored in a buffer store, then an already previously calculated auxiliary result value can be read specifically from the buffer store instead of recalculating that auxiliary result value, provided that the current calling parameters for the auxiliary function are identical to the stored calling parameters.

One example of an auxiliary function which must be evaluated repeatedly is a so-called water/steam table from the field of power station technology. Thus, for example, 25 or more evaluations of an auxiliary function which describes the temperature of a flow medium as a function of the pressure and enthalpy can be provided in the state description of a power station system. This multiple evaluation must then be carried out repeatedly in each simulation step since a series of runs through the dynamic diagram are required when calculating the Jacobi matrix by the already mentioned sequential variation of only one state variable; the number of runs required in this case corresponds at least to the number of components of the state vector.

In trials, it has been found that the method according to an embodiment of the invention for the simulation of common technical systems in some cases allows more than 90% of the recalculations of the auxiliary function to be replaced by specific reading of an already previously calculated result from the buffer store.

A number of values of calling parameters and a respectively associated auxiliary result value are advantageously stored in the buffer store. This number corresponds to the number of evaluations of the auxiliary function which are carried out on the basis of the dynamic diagram in step a).

When listing the calling arguments of the auxiliary function which occur in the course of a numerical simulation, a situation often occurs in which there is a periodicity with which the majority of the values of the calling arguments of the auxiliary function are thus repeated in renewed evaluations, since the sequential variation of only one state variable during a simulation step leaves the calling parameters of the auxiliary function unchanged, provided that the auxiliary function does not depend on the state variable that has been varied at that time. This in fact just means that knowledge of the calling arguments of the auxiliary function for one period is sufficient in order to make it possible to indicate a current function value for the auxiliary function for a current time, without needing to calculate the auxiliary function.

Instead of this, it is sufficient to specifically read the desired auxiliary result value from the buffer store. If the dynamic diagram now, for example, includes the auxiliary function n-times, then the corresponding n sets of calling parameters and the respectively associated auxiliary result value are stored in the buffer store. When a state variable is varied in order to calculate one element of the Jacobi matrix, then the dynamic diagram is now run through repeatedly, and the auxiliary function is in each case evaluated n-times in the process. In this case, as already mentioned, the values of the calling parameters often do not change, since the auxiliary function generally depends on only some of the state variables. In this case, the calculation of the auxiliary function may be replaced by specific reading of an already calculated auxiliary result value which is associated with one of the n stored calling parameters.

An embodiment of the invention makes use of the stated periodicity in order to render most of the time-consuming evaluations of the auxiliary function superfluous and to replace them by specific reading from the specifically designed buffer store.

It is also advantageous for the number of values of the calling parameters and the respectively associated auxiliary result value to be stored in the buffer store in a sequence which corresponds to the defined evaluation sequence. The expression the number of values of the calling parameters in this case means the number of sets of calling parameters, when the auxiliary function comprises two or more—that is to say a set of—calling parameters.

The state variables are varied successively in order to determine the elements of the Jacobi matrix. Further, the dynamic diagram is run through completely after each of these variations, so that the at least one auxiliary function is calculated a number of times, in the defined evaluation sequence, in each of these runs. This defined evaluation sequence remains the same, of course, in each run through the dynamic diagram.

In this refinement of an embodiment of the invention, the calling parameters and the respectively associated auxiliary result value of the at least one auxiliary function are now stored in the buffer store in the sequence corresponding to the defined evaluation sequence of the auxiliary function. Since the evaluation sequence does not change when repeated runs are made through the dynamic diagram, it is immediately clear on the basis of the evaluation sequence when calculating the auxiliary function which memory entry in the buffer store the current calling parameters of the auxiliary function must be compared with in order, if necessary, to make it possible to read an already previously calculated auxiliary result value from the buffer store, instead of having to calculate it (assuming that the current calling parameters correspond to the stored calling parameters in the appropriate buffer store entry).

If, for example, three function blocks are provided for the auxiliary function in the dynamic diagram, the auxiliary function must therefore be evaluated three times during one run through the dynamic diagram. These function blocks are processed successively, for example on the basis of a graphical representation of the dynamic diagram. Further, the corresponding calling parameters and the respective auxiliary result value of the auxiliary function are stored in precisely this evaluation sequence in the buffer store.

When another run is made through the dynamic diagram with one state variable having been varied, the function blocks which represent the auxiliary function are processed in the same defined evaluation sequence. For a comparison of the current calling parameters for a function block which represents the auxiliary function, a comparison can be carried out immediately with the corresponding entry in the buffer store, without having to search through the buffer store.

The stated comparison strategy can be provided, for example, in software. For example, this can be done by providing the buffer store with a so-called pointer which, at the start of the run through the dynamic diagram, initially points at a first memory entry in the buffer store (which, of course, may be empty when the method is restarted) and which, during the processing of a next function block which represents the auxiliary function, is then set to a next memory entry in the buffer store.

While a function block which represents the auxiliary function is actually being evaluated, the current calling parameters can now be specifically compared with those calling parameters which are marked by the current position of the pointer. If the current calling parameters and the stored calling parameters which are marked by the pointer match, then the current auxiliary result value need not be calculated, and it is sufficient to read the auxiliary result value covered by the marked memory entry in the buffer store.

After a complete run through the dynamic diagram, the pointer is then once again set to the first memory position in the buffer store, and another run through the dynamic diagram may take place. In software terms, the pointer thus has a cyclic behavior so that, during a run through the dynamic diagram, it moves from one memory entry in the buffer store to the respective next memory entry, corresponding to the multiple evaluation of the auxiliary function, until the last memory entry is reached. When another run through the dynamic diagram takes place, the pointer is then once again reset to the first memory entry.

During each multiple evaluation of the auxiliary function in step b) of the method according to an embodiment of the invention, the current values of the calling parameters are advantageously compared with the corresponding values of the calling parameters stored in the buffer store.

This comparison can be carried out very efficiently since the entries in the buffer store are in the defined evaluation sequence and it is thus possible, for example, to use the software pointer mentioned above to specifically access one memory entry in the buffer store, without having to search through the buffer store.

An embodiment of the invention also leads to a simulator for simulation of a technical system in a number of simulation steps, with the technical system being described by a state description which includes state variables for the technical system, with its Jacobi matrix being used to solve the state description. Further, the state description has at least one auxiliary function which is evaluated a number of times repeatedly in each simulation step.

A simulator, according to an embodiment of the invention, also has a buffer store in which values of calling parameters. The respectively associated auxiliary result value of the auxiliary function is stored in a defined evaluation sequence in each case in one subarea of the buffer store. In this case, on each repetition of the multiple evaluation, the auxiliary result value which is stored in this subarea is read by way of a specific read access to a subarea of the buffer store, if the current values of the calling parameters match the stored values of the calling parameters.

The specific read access may be provided, for example, by way of the software pointer which has already been mentioned in conjunction with a method according to an embodiment of the invention.

### BRIEF DESCRIPTION OF THE DRAWINGS

Further advantages, features and details of the invention will become evident from the description of illustrated embodiments given hereinbelow and the accompanying drawings, which are given by way of illustration only and thus are not limitative of the present invention, wherein:

FIG. 1 shows a method according to an embodiment of the invention, and

FIG. 2 shows a simulator according to an embodiment of the invention.

### DETAILED DESCRIPTION OF THE PREFERRED EMBODIMENTS

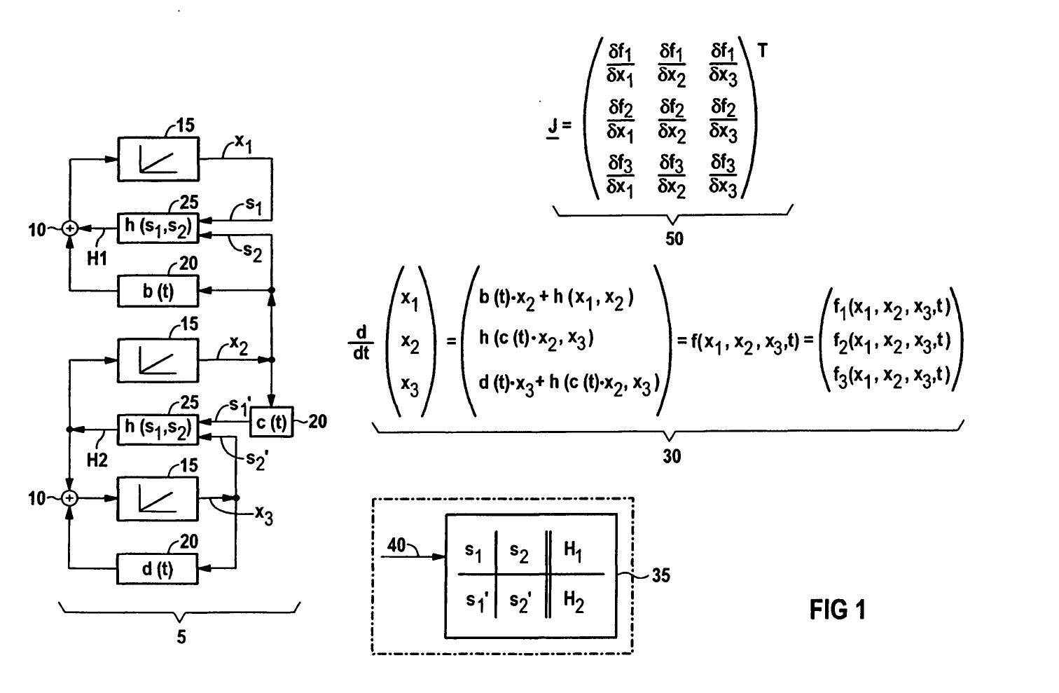

FIG. 1 illustrates a method according to an embodiment of the invention for simulation of a technical system.

The technical system is described mathematically by the state description 30. It is evident from this state description 30 that the technical system in this example is a third-order system and, in consequence, has three state variables x₁, x₂ and x₃.

The mathematical state description 30 of a technical system very frequently has an auxiliary function 25 which occurs repeatedly in the state description 30 and is thus evaluated repeatedly during the simulation of the technical system.

In the present example, the auxiliary function 25 occurs in two versions in the state description 30, firstly with the state variables x₁ and x₂ as its calling parameters s₁ and s₂, and secondly with the state variables x₂ and x₃ as its calling parameters s′₁ and s′₂. The state variable x₂ is in this case also multiplied by a time-dependent factor c (t).

The auxiliary function 25 may, for example, be a water/steam table, which has to be evaluated a number of times repeatedly in each simulation step during the simulation.

Many numerical solution algorithms which are run in particular on computers use the Jacobi matrix J to solve the state description 30. The mathematical representation 50 of this Jacobi matrix 6 is shown by way of example in FIG. 1. The elements of the Jacobi matrix J are the partial derivatives of the state equations which form the state description 30, on the basis of the state variables x₁, x₂ and x₃.

Numerically, derivatives are approximated by way of so-called difference quotients by calculating the function value for a current value of a state variable, then slightly varying the value of the state variable, and once again calculating the function value which results from the variation of the state variable. The value of the partial derivative to be determined is then approximated by the difference between the previously mentioned function values divided by the difference between the state variable and the varied state variable.

A dynamic diagram 5, which corresponds to a visualization of the state description 30 of a technical system, shows in particular the signal flows which occur during a simulation of the technical system.

Since the example in FIG. 1 is a third-order technical system, the dynamic diagram 5 in consequence has three integrators 15, at whose outputs the state variables x₁, x₂ and x₃ are produced. Corresponding to the mathematical representation of the state description 30, adders 10, multipliers 20 and two function blocks for the auxiliary function 25 are also provided in the dynamic diagram 5.

Thus, in the present example, the auxiliary function 25 is evaluated twice during one run through the dynamic diagram; first of all with the calling parameters s₁ and s₂, and secondly with the calling parameters s′₁ and s′₂. In this example, the state variables x₁ and x₂, respectively, correspond to the calling parameters s₁ and s₂, and the state variables x₂ and x₃, respectively, correspond to the calling parameters s′₁ and s′₂, with the state variable x₂ being multiplied by the time-dependent factor c (t).

The dynamic diagram 5 is run through repeatedly in each simulation step, and the auxiliary function 25 is evaluated twice during each repetition. The repeated runs through the dynamic diagram 5 are due to the fact that the values of the state variables x₁, x₂ and x₃ are varied by a magnitude value, in particular a small magnitude value, successively by way of a numerical algorithm in order to determine the elements of the Jacobi matrix J for one simulator step and the dynamic diagram 5 is then run through again. This is necessary in order to determine the difference quotients which have already been mentioned above.

In consequence, in the example shown in FIG. 1, the dynamic diagram 5 is run through four times during one simulation step; during the first run, the state description 30 is evaluated using the current values for state variables x₁, x₂ and x₃ and of the other parameters, and one state variable is varied slightly in each of the three subsequent runs, with the values of the other state variables in each case being fixed.

It can thus easily be seen that the auxiliary function 25 is evaluated twice during each run through the dynamic diagram 5, that is to say a total of eight evaluations of the auxiliary function 25 are carried out during one simulation step.

In the method according to an embodiment of the invention, an improvement is achieved in the simulation in comparison with the known methods. In particular, this is true with regard to the computation time required. Thus, the auxiliary result values H₁ and H₂ are not always recalculated during the run through the dynamic diagram 5 in which one of the state variables x₁, x₂ and x₃ is in each case varied. Instead of this, the stated auxiliary result values are read from a buffer store 35, when the current values of the calling parameters s₁ and s₂ as well as s′₁ and s′₂ match the calling parameters which are stored in the buffer store 35.

During the simulation of technical systems, such reading from the buffer store 35 may in general be carried out very frequently instead of calculating the respective auxiliary result values H₁ and H₂, since technical systems can often be described by way of a state description 30 which includes one auxiliary function 25 repeatedly, and with its auxiliary function depending in particular on only some of the state variables x₁, x₂ and x₃. When one state variable is varied in order to determine one element in the Jacobi matrix J, only those auxiliary result values H₁ and H₂ whose associated calling parameters s₁ and s₂, as well as s′₁ and s′₂ which cover the varied state variable now change. If, by way of example, the state variable x₁ is varied and a run then takes place through the dynamic diagram 5, then, during this run, only the auxiliary result value H₁ changes and not the auxiliary result value H₂. This occurs since only the calling parameters s₁ and s₂ have changed as a consequence of the variation of x₁, while the calling parameters s′₁ and s′₂ have not changed.

The auxiliary result value H₂ has thus already been calculated in the previous run through the dynamic diagram 5 and can be read from the buffer store 35, since the current values of the calling parameters s′₁ and s′₂ are identical to the stored values of the calling parameters s′₁ and s′₂ after the variation of the state variable x₁. During the recalculation of the auxiliary result value H₁, the corresponding calling parameters as well as the (new) auxiliary result value H₁ may be stored in the buffer store 35. In this case, the (old) auxiliary result value H₁, which corresponded to H₁ before the recalculation, as well as its (old) calling parameters can be overwritten by the new values.

In order to allow the buffer store 35 to be read in a specific manner, it is possible, for example, to use a pointer 40 which points at that memory entry in the buffer store 35 which corresponds to the current evaluation of the auxiliary function 25.

The repeated evaluation of the auxiliary function 25 advantageously takes place during one run through the dynamic diagram 5 in a defined evaluation sequence, such that the memory entries in the buffer store 35 are stored in precisely this sequence, and the pointer 40 points on the basis of the evaluation sequence to that memory entry in the buffer store 35 which corresponds to the current evaluation.

In the present example, the buffer store 35 has two memory entries, respectively comprising the values for the calling parameters s₁, s₂ and s′₁, s′₂ and the respective auxiliary result value H₁ or H₂. There are therefore advantageously precisely the same number of memory entries in the buffer store 35 as the number of times the auxiliary function 25 is evaluated during one run through the dynamic diagram 5. By setting the pointer 40 to that memory entry which corresponds to the current evaluation of the auxiliary function 25, it is possible to specifically access one memory entry in the buffer store 35 without having to search through the buffer store 35 during the comparison of the current values with the stored values of the calling parameters.

Thus, in the method according to an embodiment of the invention illustrated in FIG. 1, the auxiliary function is evaluated repeatedly on the basis of a dynamic diagram 5 which represent the technical system, and the values of the respective calling parameters s₁, s₂, s′₁, s′₂ of the auxiliary function 25 and of the respectively associated auxiliary result value H₁, H₂ for each evaluation are stored in a buffer store 35. The current value of one state variable x₁, x₂, x₃ is in each case varied successively, in particular by a small magnitude value, while keeping the values of the other state variables constant, and the auxiliary function 25 is evaluated repeatedly once again on the basis of the dynamic diagram 5.

Each evaluation process includes a calculation of the respective auxiliary result value H₁, H₂, if the values of the calling parameters s₁, s₂, s′₁, s′₂ of the current evaluation do not match the values of the calling parameters s₁, s₂, s′₁, s′₂ stored in the buffer store 35. It further includes reading of the auxiliary result value H₁, H₂ which is associated with the values of the calling parameters for the current evaluation from the buffer store 35 when the values of the calling parameters for the current evaluation match the values of the calling parameters which are stored in the buffer store 35. The Jacobi matrix J is determined by means of the calculated auxiliary result values H₁, H₂ and/or those read from the buffer store 35.

The specification of a method according to an embodiment of the invention is dependent on the discovery that a technical system can often be described by a state description 30 which includes one auxiliary function repeatedly. Furthermore, for the method according to an embodiment of the invention, the discovery is important that, in the case of technical systems, the auxiliary function 25 which is included repeatedly in the state description 30 generally depends on only some of the state variables x₁, x₂ and x₃, so that, when determining the difference quotients in order to determine the elements of the Jacobi matrix J by way of successive variation of the state variables x₁, x₂ and x₃, at least some of the auxiliary result values of the auxiliary function 25 often do not change during the repeated evaluation during one run through the dynamic diagram 5, when the calling parameters which are associated with the current evaluation of the auxiliary function 25 are not affected by the variation of one state variable.

The discoveries mentioned above relating to the stated typical characteristics of technical systems are neither disclosed in nor obvious from the prior art.

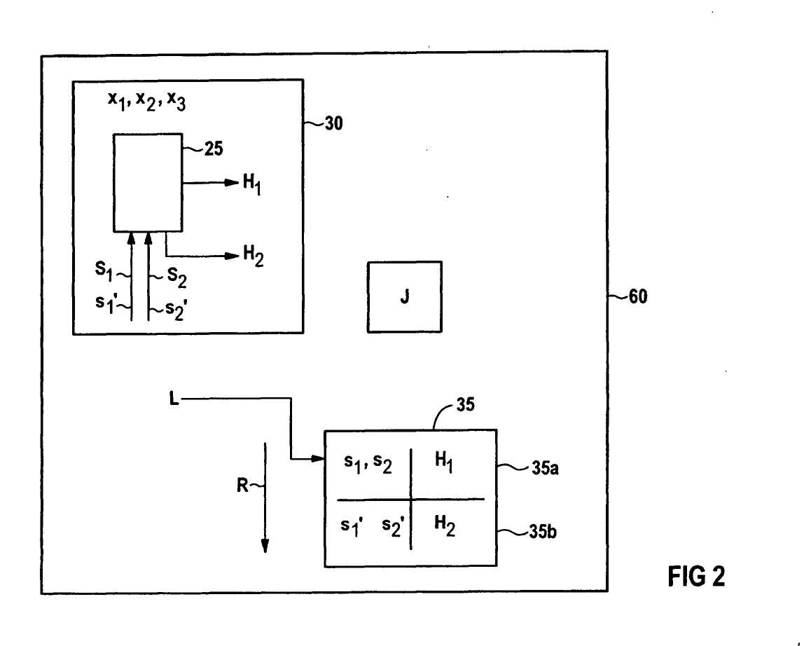

FIG. 2 shows a simulator 60 according to an embodiment of the invention for simulation of a technical system in a number of simulation steps.

The technical system is described by a state description 30. This may include state variables x₁, x₂ and x₃ for the technical system and with its Jacobi matrix J being used to solve the state description, and with the state description 30 having at least one auxiliary function 25, which is evaluated a number of times repeatedly in each simulation step. The simulator 60 according to an embodiment of the invention, has a buffer store 35 in which values of calling parameters s₁, s₂, s′₁, s′₂ and the respectively associated auxiliary result value H₁, H₂ of the auxiliary function 25 are stored in a defined evaluation sequence R in a respective subarea 35a, 35b of the buffer store. In this case, during each repetition of the multiple evaluation, a specific read access L is made to one of the subareas 35a, 35b of the buffer store 35 in order to read the auxiliary result value H₁, H₂ which is stored in this subarea, provided that the current values of the calling parameters s₁, s₂ and s′₁, s′₂, respectively, match the stored values of the calling parameters s₁, s₂ and s′₁, s′₂, respectively.

The explanation that has been given with regard to the method according to an embodiment of the invention can be applied in an analogous manner to the simulator 60 according to an embodiment of the invention, and will therefore not be repeated here.

Exemplary embodiments being thus described, it will be obvious that the same may be vaired in many ways. Such variations are not to be regarded as a departure from the spirit and scope of the present invention, and all such modifications as would be obvious to one skilled in the art are intended to be included within the scope of the following claims.

1. A method for simulation of a technical system, described by a state description including state variables and a Jacobi matrix, wherein the state description includes at least one auxiliary function to be evaluated, the method comprising
evaluating the at least one auxiliary function least two times corresponding to a dynamic diagram representing the technical system;
storing values of the respective calling parameters of the at least one auxiliary function and storing the respectively associated auxiliary result value for each evaluation;
varying a current value of each state variable, successively, by a magnitude value while maintaining values of the other state variables constant;
evaluating the at least one auxiliary function at least two more times on the basis of the dynamic diagram, wherein each evaluation includes,
calculating the respective auxiliary result value if the values of the calling parameters of the current evaluation do not match the values of the stored calling parameters, and
reading the auxiliary result value associated with the values of the calling parameters of the current evaluation from storage if the values of the calling parameters for the current evaluation match the values of the stored calling parameters stored; and
determining the Jacobi matrix from the auxiliary result values obtained.

2. The method as claimed in claim 1, wherein
a number of values of the calling parameters and the respectively associated auxiliary result value are stored, with this number corresponding to the number of evaluations of the auxiliary function carried out on the basis of the dynamic diagram.

3. The method as claimed in claim 2, wherein
the multiple evaluation of the auxiliary function is carried out in a defined evaluation sequence.

4. The method as claimed in claim 3, wherein
the number of values of the calling parameters and the associated auxiliary result value are stored in a buffer store in a sequence corresponding to the defined evaluation sequence.

5. The method as claimed in claim 4, wherein for
each multiple evaluation of the auxiliary function, the current values of the calling parameters are compared with the corresponding values of the calling parameters stored in the buffer store.

6. A simulator for simulation of a technical system in a number of simulation steps, the technical system being described by a state description including state variables for the technical system and a Jacobi matrix, wherein the state description includes at least one auxiliary function to be evaluated, the simulator comprising:
a buffer store, adapted to store values of calling parameters and the respectively associated auxiliary result value of the auxiliary function in a defined evaluation sequence in each case one subarea of the buffer store, wherein, on each repetition of the multiple evaluation, the auxiliary result value stored in a subarea is read by a specific read access to that subarea of the buffer store, if the current values of the calling parameters match the stored values of the calling parameters.

7. A device for simulation of a technical system, described by a state description including state variables and a Jacobi matrix, wherein the state description includes at least one auxiliary function to be evaluated, the method comprising:
means for evaluating the at least one auxiliary function at least two times corresponding to a dynamic diagram representing the technical system;
means for storing values of the respective calling parameters of the at least one auxiliary function and storing the respectively associated auxiliary result value for each evaluation;
means for varying a current value of each state variable, successively, by a magnitude value while maintaining values of the other state variables constant, wherein the means for evaluating evaluates the at least one auxiliary function at least two more times on the basis of the dynamic diagram, wherein each evaluation includes,
calculating the respective auxiliary result value if the values of the calling parameters of the current evaluation do not match the values of the stored calling parameters, and
reading the auxiliary result value associated with the values of the calling parameters of the current evaluation from storage if the values of the calling parameters for the current evaluation match the values of the stored calling parameters stored; and
means for determining the Jacobi matrix from the auxiliary result values obtained.

8. The device as claimed in claim 7, wherein a number of values of the calling parameters and the respectively associated auxiliary result value are stored, with this number corresponding to the number of evaluations of the auxiliary function carried out on the basis of the dynamic diagram.

9. The device as claimed in claim 8, wherein the multiple evaluation of the auxiliary function is carried out in a defined evaluation sequence.

10. The device as claimed in claim 9, wherein the number of values of the calling parameters and the associated auxiliary result value are stored in a buffer store in a sequence corresponding to the defined evaluation sequence.

11. The device as claimed in claim 10, wherein for each multiple evaluation of the auxiliary function, the current values of the calling parameters are compared with the corresponding values of the calling parameters stored in the buffer store.
